(19) United States
(12) Patent Application Publication
(10) Pub. No.: US 2007/0239872 A1
(43) Pub. Date: Oct. 11, 2007

(54) NETWORK DEVICE AND INFORMATION SYNCHRONIZATION METHOD THEREOF

(75) Inventor: CHU-FENG LIEN, Taipei Hsien (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Taipei Hsien (TW)

(21) Appl. No.: 11/693,723

(22) Filed: Mar. 30, 2007

(30) Foreign Application Priority Data
Apr. 7, 2006 (TW) 95112504

(51) Int. Cl. G06F 15/173

(52) U.S. Cl. 709/224; 709/239

(57) ABSTRACT

A network device connected between a client and a local exchange is provided, and includes a status information system, an interface system, and a management system. The status information system includes a main and a backup status information module for recording status information of the client. The interface system includes a main and a backup interface module for recording status information of the client, and for detecting whether the status information is the same as that recorded by the status information system. The management system detects whether the main status information module and/or the main interface module fail, and if failure occurs, replaces the failed main status information module and/or the failed main interface module with the backup status information module and the backup interface module respectively, auditing the status information recorded by the status information system, and transmits a replacement message to the interface system.

### BACKGROUND OF THE INVENTION

1. Field of the Invention

The invention generally relates to a device and method, and particularly to a network device and information synchronization method thereof.

2. Description of Related Art

In a typical public switching telephony network, a client is connected to a local exchange (LE) via an access network device including a main status information module, a backup status information module, a main interface module, a backup interface module, and a management module. If the main interface module or the main status information module fails, the management module uses the backup interface module or the backup status information module. However, if a client changes from an on-hook status to an off-hook status, the management module may not be able to record updated status information in the interface module, which leads to asynchronization between the interface module and the status information module, and therefore abnormal communication in the V5 network.

Therefore, a heretofore unaddressed need exists in the industry to overcome the aforementioned deficiencies and inadequacies.

### SUMMARY OF THE INVENTION

A network device connected between a client and a local exchange is provided, the network device including a status information system, an interface system, and a management system. The status information system includes a main status information module and a backup status information module for recording status information of the client. The interface system includes a main interface module and a backup interface module also for recording status information of the client, and for detecting whether the status information is the same as that recorded by the status information system. The management system detects whether the main status information module and/or the main interface module have failed, and if failure occurs, replaces the failed main status information module and/or the failed main interface module with the backup status information module and the backup interface module respectively, audits the status information recorded in the status information system, and transmits a replacement message to the interface system.

An information synchronization method applicable to a network device comprising a status information system, an interface system, and a management system is also provided. The status information system comprises a main status information module and a backup status information module. The interface system comprises a main interface module and a backup interface module. The information synchronization method comprises detecting whether the main status information module and/or the main interface module have failed; replacing the failed main status information module and/or the failed main interface module with the backup status information module and the backup interface module respectively, auditing the status information recorded by the status information system, and transmitting a replacement message to the interface system if failure occurs; detecting whether the status information recorded by the status information system is the same as that recorded by the interface system; and updating the status information recorded by the interface system with that recorded by the status information system if the status information recorded by the status information system is not the same.

Other advantages and novel features will become more apparent from the following detailed description when taken in conjunction with the accompanying drawings, in which:

### BRIEF DESCRIPTION OF THE DRAWINGS

FIG. 1 is a schematic diagram illustrating an application environment of a network device of an exemplary embodiment of the invention;

FIG. 2 is a block diagram of the network device of an exemplary embodiment of the invention;

FIG. 3 is a flowchart of an information synchronization method of another exemplary embodiment of the invention; and

FIG. 4 is a detailed flowchart of the information synchronization method shown in FIG. 3.

### DETAILED DESCRIPTION OF THE INVENTION

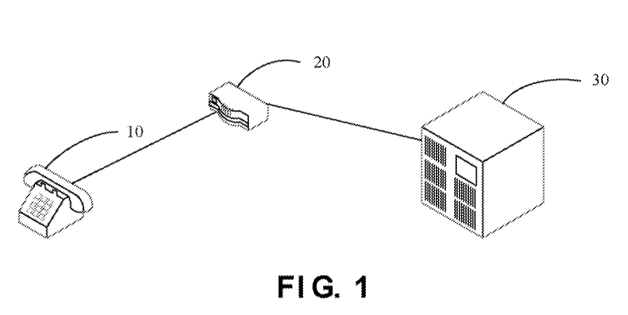

FIG. 1 is a schematic diagram illustrating an application environment of a network device 20 of an exemplary embodiment of the invention. The network device 20 is connected between a client 10 and a local exchange (LE) 30, and the LE 30 is in a communication network and may manage the network device 20 via an embedded operation channel (EOC) in a V5 interface. In this embodiment, the client 10 may be a telephone, the network device may be an access network (AN) device.

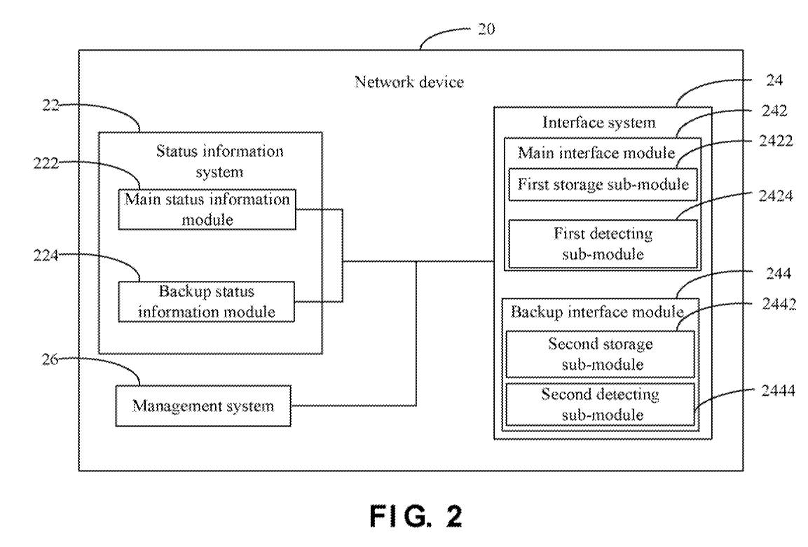

FIG. 2 is a block diagram of the network device 20 of an exemplary embodiment of the invention. The network device 20 includes a status information system 22, an interface system 24, and a management system 26.

The status information system 22 includes a main status information module 222 and a backup status information module 224. The main status information module 222 obtains status information of the client 10, and the backup status information module 224 backs up the status information obtained by the main status information module 222.

The interface system 24 includes a main interface module 242 and a backup interface module 244. The main interface module 242 obtains the status information from the status information system 22, and the backup interface module 244 backs up the status information obtained by the main interface module 242.

In this embodiment, the main interface module 242 includes a first storage sub-module 2422 and a first detecting sub-module 2424. The first storage sub-module 2422 records the status information obtained from the status information system 22, and the first detecting sub-module 2424 detects whether the status information is the same as that recorded by the backup status information module 224.

The backup interface module 244 includes a second storage sub-module 2442 and a second detecting sub-module 2444. The second storage sub-module 2442 backs up the status information in the first storage sub-module 2422, and the second detecting sub-module 2444 detects whether the status information is the same as that recorded by the main status information module 222.

The management system 26 detects whether the main status information module 222 and/or the main interface module 242 have failed, and if failure occurs, replaces the failed main status information module 222 and/or the failed main interface module 242 with the backup status information module 224 and the backup interface module 244 respectively, and transmits a replacement message to the interface system 24.

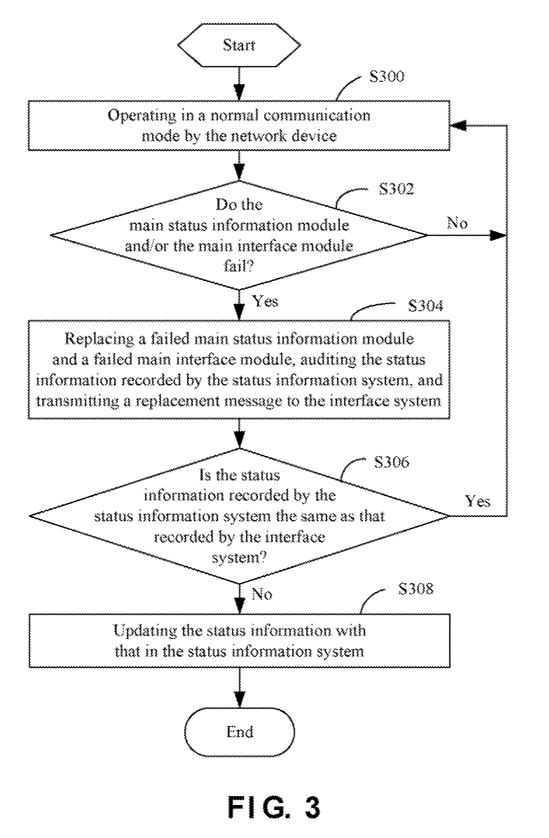

FIG. 3 is a flowchart of an information synchronization method of another exemplary embodiment of the invention.

In step S300, the network device 20 operates in a normal communication mode.

In step S302, the management system 26 detects whether the main status information module 222 and/or the main interface module 242 have failed. If the main status information module 222 and/or the main interface module 242 have failed, the process proceeds to step S304, otherwise the process returns to step S300.

In step S304, the management system 26 replaces the failed main status information module 222 and/or the failed main interface module 242, audits the status information recorded by the status information system 22, and transmits a replacement message to the interface system 24. In this embodiment, the sequence between auditing the status information recorded by the status information system 22 and transmitting the replacement message is not restricted. If the main status information module 222 fails, the management system 26 replaces the main status information module 222 with the backup status information module 224. If the main interface module 242 fails, the management system 26 replaces the main interface module 242 with the backup interface module 244.

In step S306, the first detecting sub-module 2424 or the second detecting sub-module 2444 detects whether the status information recorded by the status information system 22 is the same as that recorded by the interface system 24. In detail, if the main status information module 222 fails, the first detecting sub-module 2424 detects whether the status information in the first storage sub-module 2422 is the same as that in the backup status information module 224. If the main interface module 242 fails, the second detecting sub-module 2444 detects whether the status information in the second storage sub-module 2442 is the same as that in the main status information module 222. If the status information in the first storage sub-module 2422 is not the same as that in the backup status information module 224, or the status information in the second storage sub-module 2442 is not the same as that in the main status information module 222, the process proceeds to step S308, otherwise the process returns to step S300.

In step S308, the interface system 24 updates status information thereof with that recorded in the status information system 22.

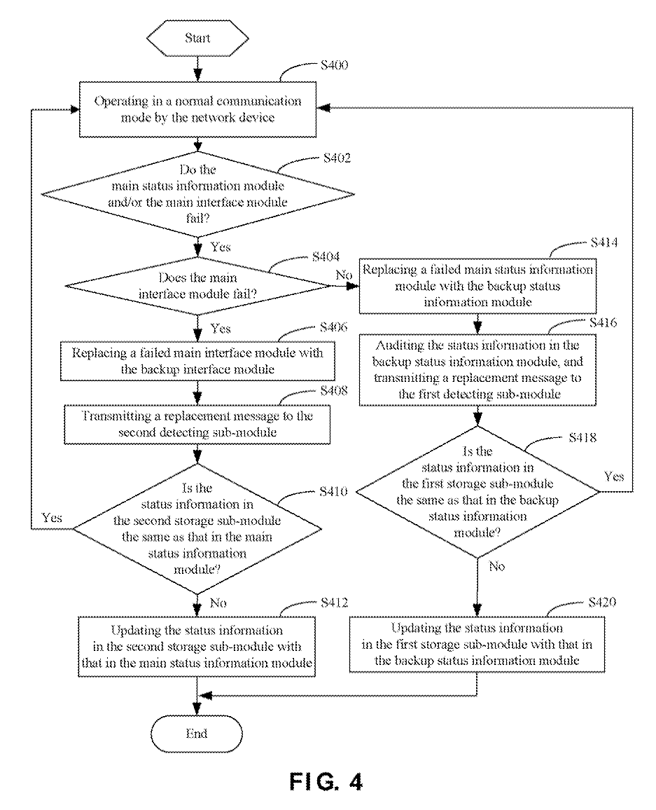

FIG. 4 is a detailed flowchart of the information synchronization method in FIG. 3.

In step S400, the network device 20 operates in a normal communication mode.

In step S402, the management system 26 detects whether the main status information module 222 and/or the main interface module 242 have failed. If the main status information module 222 and/or the main interface module 242 have failed, the process proceeds to step S404, otherwise the process returns to step S400.

In step S404, the management system 26 detects whether the the main interface module 242 has failed. If the main interface module 242 has failed, the process proceeds to step S406, otherwise the process proceeds to step S414.

In step S406, the management system 26 replaces the failed main interface module 242 with the backup interface module 244.

In step S408, the management system 26 transmits a replacement message to the second detecting sub-module 2444.

In step S410, the second detecting sub-module 2444 detects whether the status information in the second storage sub-module 2442 is the same as that in the main status information module 222. If the status information in the second storage sub-module 2442 is not the same as that in the main status information module 222, the process proceeds to step S412, otherwise the process returns to step S400.

In step S412, the second detecting sub-module 2444 updates the status information in the second storage sub-module 2442 with that in the main status information module 222.

In step S414, the management system 26 replaces the failed main status information module 222 with the backup status information module 224.

In step S416, the management system 26 audits the status information in the backup information module 224, and transmits a replacement message to the first detecting sub-module 2424. In the exemplary embodiment, the backup status information module 224 may back up the status information from the main status information module 222 by a predetermined backup frequency. The backup status information module 224 may back up the latest status information from the main status information module 222 before the main status information module 222 fails, and accordingly the status information recorded in the backup status information module 224 is right. The backup status information module 224 may back up the latest status information from the main status information module 222 after the main status information module 222 fails, and accordingly the status information recorded in the backup status information module 224 is wrong. Therefore, the management system 26 needs to audit the status information recorded in the backup status information module 224 to determine the latest and actual status information of the client 10. The management system 26 detects the latest and actual status information of the client, and then updates the status information recorded in the backup status information module 224.

In step S418, the first detecting sub-module 2424 detects whether the status information in the first storage sub-module 2422 is the same as that in the backup status information module 224. If the status information in the first storage sub-module 2422 is not the same as that in the backup status information module 224, the process proceeds to step S420, otherwise the process returns to step S400.

In step S420, the first detecting sub-module 2424 updates the status information in the first storage sub-module 2422 with that in the backup status information module 224.

What is claimed is:

1. A network device connected between a client and a local exchange, comprising:
a status information system comprising a main status information module and a backup status information module for recording status information of the client;
an interface system comprising a main interface module and a backup interface module for recording status information of the client, and for detecting whether the status information is the same as that recorded by the status information system; and
a management system for detecting whether the main status information module and/or the main interface module fail, and for replacing the failed main status information module and/or the failed main interface module with the backup status information module and the backup interface module respectively, auditing the status information recorded in the backup status information module, and transmitting a replacement message to the interface system if failure occurs.

2. The network device in accordance with claim 1, wherein the main status information module obtains the status information of the client.

3. The network device in accordance with claim 2, wherein the status information module backups the status information obtained by the main status information module.

4. The network device in accordance with claim 3, wherein the main interface module obtains the status information from the status information system.

5. The network device in accordance with claim 4, wherein the main interface module comprises a first storage sub-module for storing the status information obtained from the status information system.

6. The network device in accordance with claim 5, wherein the main interface system further comprises a first detection sub-module for detecting whether the status information stored in the first storage sub-module is the same as that in the backup status information module.

7. The network device in accordance with claim 5, wherein the backup interface module comprises a second storage sub-module for backing up the status information in the first storage sub-module.

8. The network device in accordance with claim 7, wherein the backup interface module further comprises a second detection sub-module for detecting whether the status information in the second storage sub-module is the same as that in the main status information module.

9. An information synchronization method applicable to a network device comprising a status information system, an interface system, and a management system, the status information system comprising a main status information module and a backup status information module, and the interface system comprising a main interface module and a backup interface module, wherein the information synchronization method comprises:
detecting whether the main status information module and/or the main interface module fail;
replacing the failed main status information module and/or the failed main interface module with the backup status information module and the backup interface module respectively, auditing the status information recorded by the status information system, and transmitting a replacement message to the interface system if failure occurs;
detecting whether the status information recorded by the status information system is the same as that recorded by the interface system; and
updating the status information recorded by the interface system with that recorded by the status information system if the status information recorded by the status information system is not the same as that recorded by the interface system.

10. The information synchronization method in accordance with claim 9, further comprising determining whether the main interface module fails.

11. The information synchronization method in accordance with claim 10, further comprising replacing the failed main interface module with the backup interface module and transmitting the replacement message to the second detecting sub-module if the main interface module fails.

12. The information synchronization method in accordance with claim 11, further comprising detecting whether the status information in the second storage sub-module is the same as that in the main status information module.

13. The information synchronization method in accordance with claim 12, further comprising updating the status information in the second storage sub-module with that in the main status information module if the status information in the second storage sub-module is not the same as that in the main status information module.

14. The information synchronization method in accordance with claim 11, further comprising replacing the failed main status information module with the backup status information module and transmitting the replacement message to the first detecting sub-module if the main interface module does not fail.

15. The information synchronization method in accordance with claim 14, further comprising detecting whether the status information in the first storage sub-module is the same as that in the backup status information module.

16. The information synchronization method in accordance with claim 15, further comprising updating the status information in the first storage sub-module with that in the backup status information module if the status information in the first storage sub-module is not the same as that in the backup status information module.

17. A method applicable to a network device information communicable with a client for information synchronization, comprising:
detecting a main status information module of a network device information communicable with a client to decide whether said main status information module has been failed;
replacing said failed main status information module by a backup status information module of said network device;
verifying status information of said client recorded in said backup status information module by auditing said status information of said client;
detecting status information recorded in an interface system of said network device information communicable with a communication network to decide whether said status information recorded in said interface system of said network device is same as said verified status information recorded in said backup status information module; and
updating said status information recorded in said interface system by means of said verified status information recorded in said backup status information module when said status information recorded in said interface system of said network device is not same as said verified status information recorded in said backup status information module.
